(19) United States
(12) Patent Application Publication
(10) Pub. No.: US 2024/0135241 A1
(43) Pub. Date: Apr. 25, 2024

(54) INTELLIGENT DEVICE DATA FILTER FOR MACHINE LEARNING

(71) Applicant: INTERNATIONAL BUSINESS MACHINES CORPORATION, ARMONK, NY (US)

(72) Inventors: Janice Yang, Cambridge, MA (US); Kate Hogan, St. Louis, MO (US); Arnav Aggarwal, Los Altos, CA (US); Ethan Weaver, Morgantown, WV (US); John S. Werner, Fishkill, NY (US)

(21) Appl. No.: 18/048,610

(22) Filed: Oct. 20, 2022

(51) Int. Cl. G06N 20/00; G06N 5/04

(52) U.S. Cl. CPC G06N 20/00; G06N 5/04

(57) ABSTRACT

In an approach, a processor receives, at an edge device running a local instance of a machine learning (ML) model, a set of inference data comprising a plurality of datapoints, wherein the local instance of the ML model is a deployed version of the ML model running in a cloud environment, and wherein the ML model was trained in the cloud environment and then deployed to the edge device. A processor runs the plurality of datapoints through one or more filters to determine a probability for each datapoint of whether a respective datapoint should be sent back to the cloud environment and used for retraining the ML model. A processor determines, for each datapoint, whether the probability for the respective datapoint meets a send back threshold that is required to be met before the respective datapoint is sent back to the cloud environment.

### BACKGROUND OF THE INVENTION

The present invention relates generally to the field of machine learning, and more particularly to filtering and returning retraining data to counter drift and bias in machine learning models at the edge.

The “edge” is a term that refers to a location, far from the cloud or a big data center, where you have a computer device (edge device) capable of running (edge) applications. Edge computing is the act of running workloads on these edge devices. Machine learning at the edge is a concept that brings the capability of running machine learning models locally to edge devices. These machine learning models can be invoked by the edge application. Machine learning at the edge is important for many scenarios where raw data is collected from sources far from the cloud.

### SUMMARY

Aspects of an embodiment of the present invention disclose a method, computer program product, and computer system for filtering and returning retraining data to counter drift and bias in machine learning models at the edge. A processor receives, at an edge device running a local instance of a machine learning (ML) model, a set of inference data comprising a plurality of datapoints, wherein the local instance of the ML model is a deployed version of the ML model running in a cloud environment, and wherein the ML model was trained in the cloud environment and then deployed to the edge device. A processor runs the plurality of datapoints through one or more filters to determine a probability for each datapoint of whether a respective datapoint should be sent back to the cloud environment and used for retraining the ML model. A processor determines, for each datapoint, whether the probability for the respective datapoint meets a send back threshold that is required to be met before the respective datapoint is sent back to the cloud environment.

### BRIEF DESCRIPTION OF THE DRAWINGS

FIG. 1A is a functional block diagram illustrating a part of a distributed data processing environment in which an intelligent device data filter program is run on an edge computing device, in accordance with an embodiment of the present invention.

FIG. 1B is a functional block diagram illustrating another part of the distributed data processing environment in which the intelligent device data filter program is run on an edge computing device and an edge server of the distributed data processing environment, in accordance with an embodiment of the present invention.

FIG. 1C is a functional block diagram illustrating yet another part of the distributed data processing environment in which the intelligent device data filter program is run on an edge server of the distributed data processing environment, in accordance with an embodiment of the present invention.

FIG. 2 is a flowchart depicting operational steps of the intelligent device data filter program, for filtering and returning retraining data to counter drift and bias in machine learning models at the edge, running on an edge computing device and/or an edge server of the distributed data processing environments of FIG. 1A-C, in accordance with an embodiment of the present invention.

FIG. 3 depicts a block diagram of components of the distributed data processing environment of FIG. 1A-C, for running the intelligent device data filter program, in accordance with an embodiment of the present invention.

### DETAILED DESCRIPTION

Embodiments of the present invention recognize that machine learning models are never completely accurate. These models need monitoring and retraining even after they are deployed. The most valuable data for retaining is real data points for categories that a machine learning model performed inference poorly on. However, unless there is always live human feedback, it is difficult to know where the model is failing. For example, if we can detect that a machine learning model is performing poorly for a certain group, additional data from that group would be key for retraining. Data seen on edge devices that are using the machine learning model may differ significantly from data used for training or even from data other devices see. This leads to the deployed models becoming less and less accurate. Knowing when data consistency has changed is a big challenge.

Collecting data that the machine learning model performs biases and/or incorrect inferences on as well as data that exemplifies drift, i.e., data that is significantly different from the training data, is essential to model retraining. However, edge devices usually get very large amounts of inference data, sometimes even a constant stream. All of this inference data is desirable from a machine learning point of view as generally more data leads to a better model. However, all the data cannot simply be sent back to the cloud as sending back large amounts of data negates many of the upsides of operating at the edge. Constantly sending back large amounts of data overwhelms network bandwidth and slows other data transfers over a network. Additionally, sending back all the data from edge devices, which can operate in fleets of thousands, leaves the data scientist with an impractical amount of data that they must sift through, select what to use for retraining, and label all the data points. Embodiments of the present invention recognize that deciding which of these data points to collect at the edge and send back for monitoring and retraining, without overwhelming the network, is a challenge.

Thus, embodiments of the present invention provide a system and method for filtering and returning retraining data to counter drift and bias in machine learning models at the edge. The system comprises a main machine learning model running in the cloud that is deployed to a plurality of edge devices. Each edge device must determine which of the inference data to send back to the cloud data center for retraining of the main machine learning model. There are three main categories of data to send back: (1) data from groups that the model may show bias against, (2) data that the model encounters that may be different from original training data (i.e., drift), and (3) feedback data that comes from transactions where end users disagree with the model's predictions. For each category, the goal is to collect and send data back to the cloud that would be valuable for retraining and improving the quality of the model, while discarding repeat and/or insignificant data.

Embodiments of the present invention utilize an intelligent device data filter program that runs directly on an edge device along with the machine learning model. In the case that the edge device has limited compute power or storage resources (e.g., small Internet of Things (IoT) devices), the filtering workload of the program can run fully on an edge server or can be split between the edge device and an edge server with the more computationally heavy filtering done by a machine learning model on the edge server. Alternatively, the intelligent device data filter program can be configured to run only when the machine learning model on the edge device and/or edge server is not utilizing as much of its compute resources, i.e., the use of hardware in the edge device and/or edge server (e.g., processors, RAM, etc.) to perform tasks required and handled by the edge device and/or edge server.

Data from the edge will be sent back to the cloud according to a priority ranking for each data point. By using this filtering method before data transport, embodiments of the present invention significantly minimize the amount of data that needs to travel through the network while providing the data that is most useful for model monitoring and retraining. Data transfer will occur when network conditions are observed to have sufficient bandwidth.

Implementation of embodiments of the invention may take a variety of forms, and exemplary implementation details are discussed subsequently with reference to the Figures.

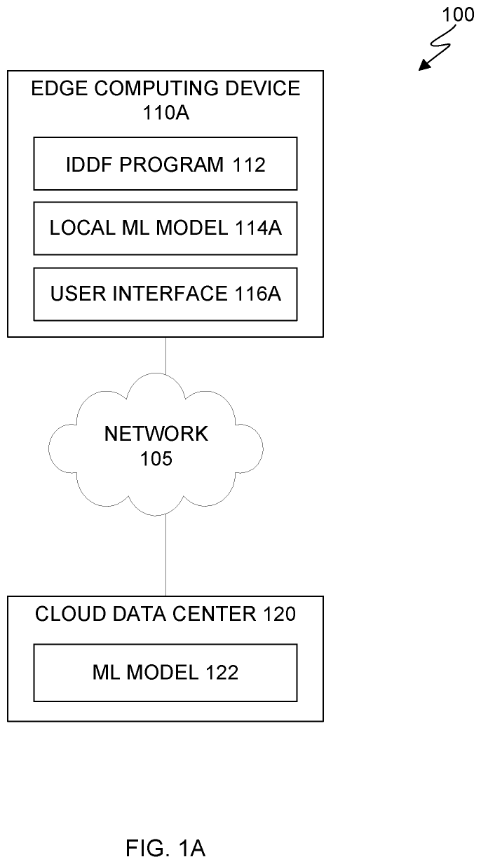

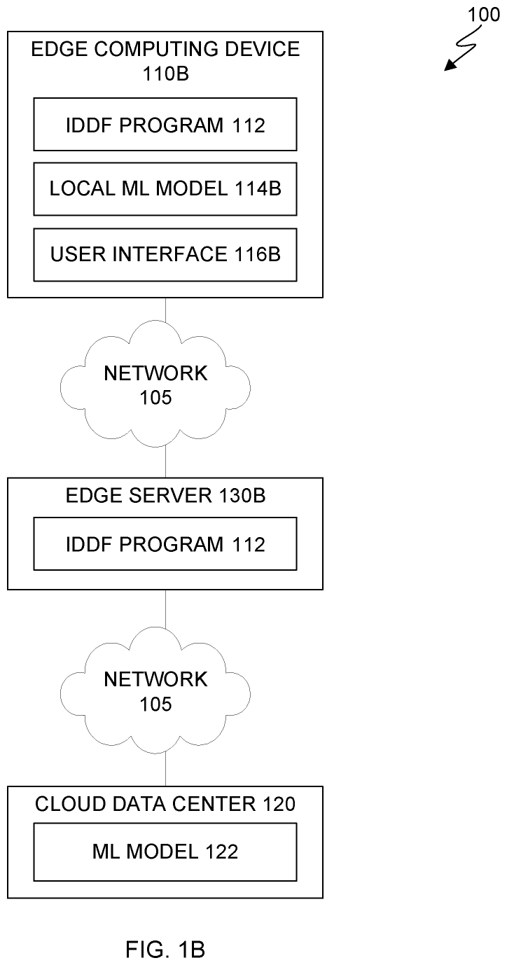

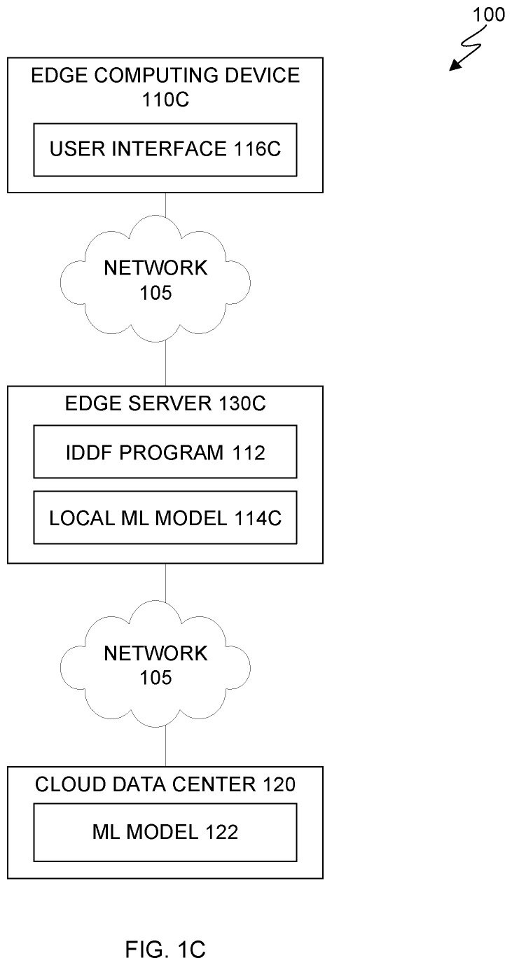

FIGS. 1A-1C each depict a functional block diagram illustrating a part of a distributed data processing environment, generally designated 100, each in accordance with one embodiment of the present invention. FIGS. 1A-1C each depict a different embodiment of how intelligent device data filter (IDDF) program 112 can be implemented in an environment involving a cloud data center in communication with any number of edge computing devices, and, in some embodiments, any number of edge servers depending on the computing capabilities of the edge computing devices.

FIG. 1A is a functional block diagram illustrating a part of distributed data processing environment 100 in which IDDF program 112 is run entirely on edge computing device 110A, in accordance with an embodiment of the present invention. FIG. 1B is a functional block diagram illustrating another part of distributed data processing environment 100 in which IDDF program 112 is run partly on edge computing device 110B and partly on edge server 130B, in accordance with an embodiment of the present invention. FIG. 1C is a functional block diagram illustrating yet another part of distributed data processing environment 100 in which IDDF program 112 is run entirely on edge server 130C, in accordance with an embodiment of the present invention. The term “distributed,” as used herein, describes a computer system that includes multiple, physically distinct devices that operate together as a single computer system. FIGS. 1A-1C each provide only an illustration of one implementation and does not imply any limitations with regard to the environments in which different embodiments may be implemented. Many modifications to the depicted environment may be made by those skilled in the art without departing from the scope of the invention as recited by the claims.

As shown in FIGS. 1A-1C, distributed data processing environment 100 includes edge computing device 110A and cloud data center 120, interconnected over network 105; edge computing device 110B, edge server 130B, and cloud data center 120, interconnected over network 105; and edge computing device 110C, edge server 130C, and cloud data center 120, interconnected over network 105. Network 105 can be, for example, a telecommunications network, a local area network (LAN), a wide area network (WAN), such as the Internet, or a combination of the three, and can include wired, wireless, or fiber optic connections. Network 105 can include one or more wired and/or wireless networks capable of receiving and transmitting data, voice, and/or video signals, including multimedia signals that include voice, data, and video information. In general, network 105 can be any combination of connections and protocols that will support communications between edge computing device 110A and cloud data center 120; edge computing device 110B, edge server 130B, and cloud data center 120; edge computing device 110C, edge server 130C, and cloud data center 120; and other computing devices (not shown) within distributed data processing environment 100.

In FIGS. 1A-1C, cloud data center 120 operates as any type of cloud environment (e.g., public, private, etc.) with centralized compute resources and data storage resources sufficient for training and running large ML models, e.g., ML model 122. Cloud data center 120 represents the large-scale data analysis, processing, and storage systems. This is the core of an edge network. There may be local or regional edge data centers between edge computing devices 110A-C and cloud data center 120 (i.e., nodes or fog), but cloud data center 120 represents the core of the network where everything originates from and where a data scientist receives the filtered inference data from edge computing devices 110A-C and deploys updates to the main ML model 122. In some embodiments, cloud data center 120 is a standard non-cloud network such as an on-premise or client side server.

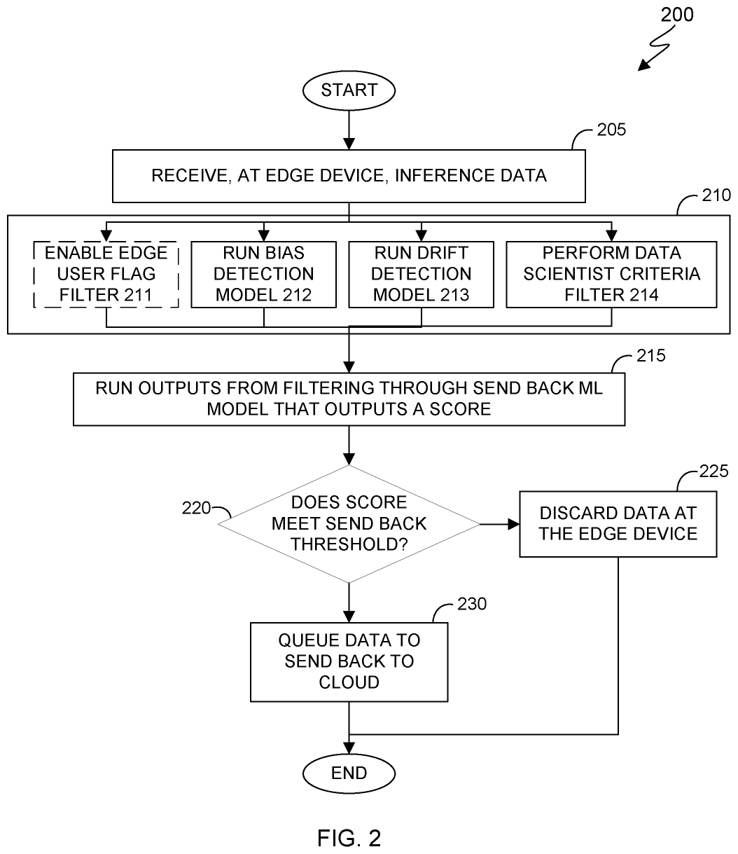

In FIGS. 1A-C, ML model 122 is a supervised and/or unsupervised ML model in the cloud data center 120, i.e., the main ML model, that is trained for the first time using data the data scientist has developed and then deployed to edge computing devices 110A-B and edge server 130C (e.g., local ML model 114A-C, respectively). Then, when filtered data is sent back to cloud data center 120 based on IDDF program 112, ML model 122 is retrained using the received filtered data, and an updated version of ML model 122 is redeployed as an updated local ML model. In an embodiment, the redeployed local ML model (e.g., local ML model 114A-C) may have small changes from ML model 122 (e.g., smaller in size based on the resources of edge computing devices 110A-C, the physical location of edge computing devices 110A-C, and/or the previous data seen by edge computing devices 110A-C). In an embodiment, ML model 122 infers a function using labeled training data and is built such that class labels for previously unseen data received by edge devices, e.g., edge computing devices 110A-C, is correctly determined to improve ML model 122 performance. In an embodiment, ML model 122 is initialized using a set of labeled training data that ideally represents what will be seen in the field by edge computing devices 110, but it is nearly impossible to have a perfect training dataset so ML model 122 may not perform well in some instances and will then be updated based on the filtered inference data that is sent back to cloud data center 120 via IDDF program 112 using the method described in FIG. 2. In an embodiment in which ML model 122 is a supervised ML model, typical use cases include object recognition, speech recognition, pattern recognition, spam detection, etc.

In FIGS. 1A-C, intelligent device data filter (IDDF) program 112 operates to filter and return retraining data to counter drift and bias in machine learning models at the edge by determining which inference data received at an edge device to send back to a cloud data center for ML model retraining. In the depicted embodiment, IDDF program 112 is a standalone program. In another embodiment, IDDF program 112 may be integrated into another software product, e.g., machine learning on the edge software package. In FIG. 1A, IDDF program 112 is run entirely on edge computing device 110A. In FIG. 1B, IDDF program 112 is run partly on edge computing device 110B and partly on edge server 130B, in which how much of IDDF program 112 is run on edge computing device 110B versus edge server 130B depends on the computing resources of edge computing device 110B. In FIG. 1C, IDDF program 112 is run entirely on edge server 130C. IDDF program 112 is depicted and described in further detail with respect to FIG. 2.

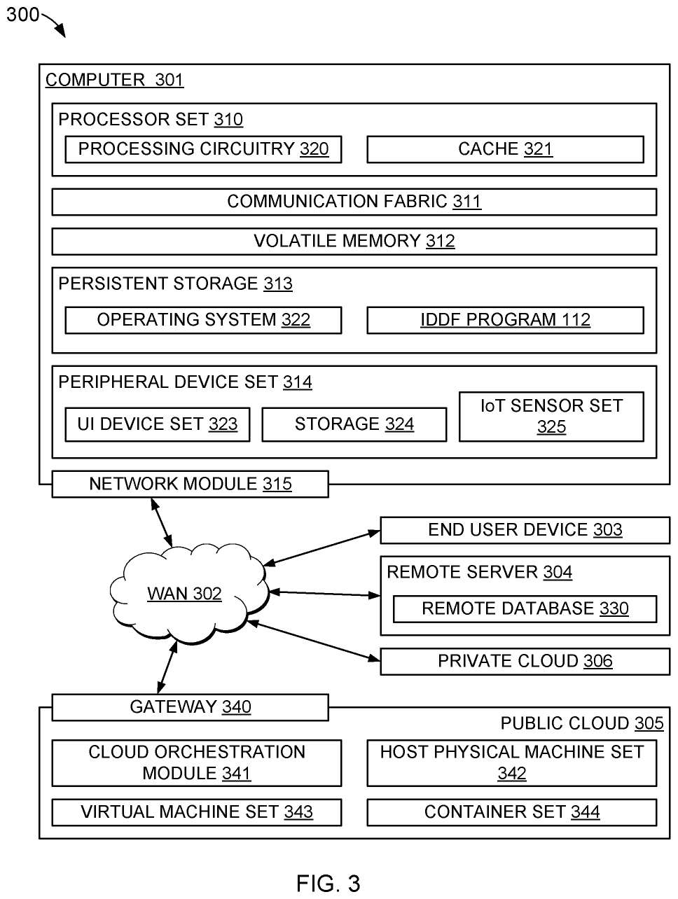

In FIG. 1A, edge computing device 110A operates as an edge computing device that receives inference data, runs intelligent device data filter program 112 and local machine learning (ML) model 114A, and (in some embodiments) enables a user to interact through user interface 116A. In the depicted embodiment, edge computing device 110A includes intelligent device data filter program 112, local machine learning model 114A, and user interface 116A. In an embodiment, edge computing device 110A can be a laptop computer, a tablet computer, a smart phone, a smart watch, an e-reader, smart glasses, wearable computer, or any programmable electronic device capable of communicating with various components and devices within distributed data processing environment 100, via network 105. In general, edge computing device 110A represents one or more programmable electronic devices or combination of programmable electronic devices capable of executing machine readable program instructions and communicating with other computing devices (not shown) within distributed data processing environment 100 via a network, such as network 105. Edge computing device 110A may include internal and external hardware components, as depicted and described in further detail with respect to FIG. 3.

In FIG. 1A, local machine learning (ML) model 114A is a ML model local to edge computing device 110A and being monitored by IDDF program 112. Local ML model 114A is an instance of a main ML model (e.g., ML model 122) that has been deployed from the cloud (e.g., cloud data center 120) to edge computing device 110A to enable machine learning at the edge through a ML application (not shown) on edge computing device 110A. In an embodiment, a ML application (not shown) comprises IDDF program 112, local ML model 114A, and user interface 116A with IDDF program 112 and local ML model 114A invisible to edge computing device 110A or a user of edge computing device 110A (i.e., running in the background). In some embodiments, the ML application has a user interface (e.g., user interface 116A) enabling a user of the ML application to give feedback on outputs (i.e., predictions) of local ML model 114A. Inference data received by edge computing device 110A is received by IDDF program 112 to determine what data to send back to cloud data center 120 for retraining of ML model 122 and what data can be discarded. When ML model 122 is updated based on the retraining, an updated ML model 122 is redeployed to edge computing device 110A.

In FIG. 1A, user interface 116A provides an interface between IDDF program 112 on edge computing device 110A and a user of edge computing device 110A. In one embodiment, user interface 116A is an edge interface of the ML application (as described above) software running on edge computing device 110A. In one embodiment, user interface 116B may be a graphical user interface (GUI) or a web user interface (WUI) that can display text, documents, web browser windows, user options, application interfaces, and instructions for operation, and include the information (such as graphic, text, and sound) that a program presents to a user and the control sequences the user employs to control IDDF program 112. User interface 116A optionally enables a user of edge computing device 110A to provide user feedback on inference data output by local ML model 114A, in which this user feedback acts as one filter of IDDF program 112, as described in sub-step 311 of FIG. 2 below.

In FIG. 1B, edge computing device 110B operates as an edge computing device that receives inference data, runs intelligent device data filter program 112 and local machine learning (ML) model 114B, and (in some embodiments) enables a user to interact through user interface 116B. In the depicted embodiment, edge computing device 110B includes intelligent device data filter program 112, local machine learning model 114B, and user interface 116B. In an embodiment, edge computing device 110B can be a laptop computer, a tablet computer, a smart phone, a smart watch, an e-reader, smart glasses, wearable computer, or any programmable electronic device capable of communicating with various components and devices within distributed data processing environment 100, via network 105. In general, edge computing device 110B represents one or more programmable electronic devices or combination of programmable electronic devices capable of executing machine readable program instructions and communicating with other computing devices (not shown) within distributed data processing environment 100 via a network, such as network 105. Edge computing device 110B may include internal and external hardware components, as depicted and described in further detail with respect to FIG. 3.

In FIG. 1B, local machine learning (ML) model 114B is a ML model local to edge computing device 110A and being monitored by IDDF program 112. Local ML model 114B is an instance of a main ML model (e.g., ML model 122) that has been deployed from the cloud (e.g., cloud data center 120) to edge computing device 110B to enable machine learning at the edge through a ML application (not shown) on edge computing device 110B. In an embodiment, a ML application (not shown) comprises IDDF program 112, local ML model 114B, and user interface 116B with IDDF program 112 and local ML model 114B invisible to edge computing device 110B or a user of edge computing device 110B (i.e., running in the background). In some embodiments, the ML application has a user interface (e.g., user interface 116B) enabling a user of the ML application to give feedback on outputs (i.e., predictions) of local ML model 114B. Inference data received by edge computing device 110B is received by IDDF program 112 to determine what data to send back to cloud data center 120 for retraining of ML model 122 and what data can be discarded. When ML model 122 is updated based on the retraining, an updated ML model 122 is redeployed to edge computing device 110B.

In FIG. 1B, user interface 116B provides an interface between IDDF program 112 on edge computing device 110B and a user of edge computing device 110B. In one embodiment, user interface 116B is an edge interface of the ML application (as described above) software running on edge computing device 110B. In one embodiment, user interface 116B may be a graphical user interface (GUI) or a web user interface (WUI) that can display text, documents, web browser windows, user options, application interfaces, and instructions for operation, and include the information (such as graphic, text, and sound) that a program presents to a user and the control sequences the user employs to control IDDF program 112. User interface 116B optionally enables a user of edge computing device 110B to provide user feedback on inference data output by local ML model 114B, in which this user feedback acts as one filter of IDDF program 112, as described in sub-step 311 of FIG. 2 below.

In FIG. 1B, edge server 130B is a computer server that is located physically close to edge computing device 110B. In general, edge servers are located physically close to endpoints (i.e., edge devices) to reduce latency for operation of the endpoints. Edge server 130B can be a standalone computing device, a management server, a web server, a mobile computing device, or any other electronic device or computing system capable of receiving, sending, and processing data. In other embodiments, edge server 130B can represent a server computing system utilizing multiple computers as a server system, such as in a cloud computing environment. In another embodiment, edge server 130B can be a laptop computer, a tablet computer, a netbook computer, a personal computer (PC), a desktop computer, or any programmable electronic device capable of communicating with edge computing device 110B, cloud data center 120, and other computing devices (not shown) within distributed data processing environment 100 via network 105. In another embodiment, edge server 130B represents a computing system utilizing clustered computers and components (e.g., database server computers, application server computers, etc.) that act as a single pool of seamless resources when accessed within distributed data processing environment 100. Edge server 130B optionally includes an instance of IDDF program 112 in which a portion of the filtering and model scoring is done on edge server 130B as opposed to edge computing device 110B to not overwhelm an edge device with too big of a computational workload, as described below with reference to FIG. 2. Edge server 130B may include internal and external hardware components, as depicted and described in further detail with respect to FIG. 3.

When IDDF program 112 cannot be run completely on edge computing device 1B, IDDF program 112 can be hosted by an edge server (e.g., edge server 130B) that the edge computing device 110B is in communication with, as shown in FIG. 1B. Some filtering of IDDF program 112 may occur on the edge device before a majority of the filtering and running of a send back ML model is run on IDDF program 112 of edge server 130B. This is done in cases where edge computing device 110B is a simple device that does not have the capacity to perform additional tasks beyond its designed function or if the implementation preference is to use the edge server such that the edge computing device can use its resources for performing other tasks. This is also done to preserve the benefit of edge computing because sending all the data from thousands of edge devices to an edge server would still take up a large portion of the network and defeat the purpose of data filtering. IDDF program 112 on edge server 130B only ingests data from the same type of model and edge device that IDDF program 112 is trained to look for. All other types of devices that are registered to edge server 130B and relaying information are ignored by IDDF program 112 on edge server 130B. In some embodiments where edge server 130B connects to multiple different types of edge devices, multiple different instances of IDDF program 112 may exist for the different edge devices running different local ML models.

In embodiments in which the user feedback filter is enabled with a user interface (e.g., user interface 116B), the filtering done on the edge device (e.g., edge computing device 110B) is done by an edge user flagging datapoints that the edge user believes are incorrect predictions (as described in sub-step 211 of FIG. 2 below). These flagged datapoints will be prioritized by IDDF program 112 to be sent to the edge server (e.g., edge server 130B) since they are the least computationally heavy operations of IDDF program 112 and the most accurate account of local ML model 114B performing incorrectly or correctly. In some embodiments, some or all remaining unflagged datapoints will be sent to edge server 130B for further filtering according to network constraints. Once edge server 130B receives data from edge computing device 110B, IDDF program 112 on edge server 130B runs the remaining filters and/or a send back ML model (as described in step 210 and/or 215 in FIG. 2 below).

In FIG. 1C, edge computing device 110C operates as an edge computing device that receives inference data, sends the inference data to edge server 130C, and (in some embodiments) enables a user to interact through user interface 116C. In the depicted embodiment, edge computing device 110C includes user interface 116C. In an embodiment, edge computing device 110C can be a laptop computer, a tablet computer, a smart phone, a smart watch, an e-reader, smart glasses, wearable computer, or any programmable electronic device capable of communicating with various components and devices within distributed data processing environment 100, via network 105. In general, edge computing device 110C represents one or more programmable electronic devices or combination of programmable electronic devices capable of executing machine readable program instructions and communicating with other computing devices (not shown) within distributed data processing environment 100 via a network, such as network 105. Edge computing device 110C may include internal and external hardware components, as depicted and described in further detail with respect to FIG. 3.

User interface 116C provides an interface between IDDF program 112 on edge computing device 110C and a user of edge computing device 110C. In one embodiment, user interface 116C is an edge interface of the ML application (as described above) software running on edge computing device 110C. In one embodiment, user interface 116C may be a graphical user interface (GUI) or a web user interface (WUI) that can display text, documents, web browser windows, user options, application interfaces, and instructions for operation, and include the information (such as graphic, text, and sound) that a program presents to a user and the control sequences the user employs to control IDDF program 112. User interface 116C optionally enables a user of edge computing device 110C to provide user feedback on inference data received by edge computing device 110C, in which this user feedback acts as one filter of IDDF program 112, as described in sub-step 211 of FIG. 2 below.

Edge server 130C is a computer server that is located physically close to edge computing device 110C. In general, edge servers are located physically close to endpoints (i.e., edge devices) to reduce latency for operation of the endpoints. Edge server 130C can be a standalone computing device, a management server, a web server, a mobile computing device, or any other electronic device or computing system capable of receiving, sending, and processing data. In other embodiments, edge server 130C can represent a server computing system utilizing multiple computers as a server system, such as in a cloud computing environment. In another embodiment, edge server 130C can be a laptop computer, a tablet computer, a netbook computer, a personal computer (PC), a desktop computer, or any programmable electronic device capable of communicating with edge computing device 110C, cloud data center 120, and other computing devices (not shown) within distributed data processing environment 100 via network 105. In another embodiment, edge server 130C represents a computing system utilizing clustered computers and components (e.g., database server computers, application server computers, etc.) that act as a single pool of seamless resources when accessed within distributed data processing environment 100. Edge server 130C includes an instance of IDDF program 112 in which the filtering and model scoring is done on edge server 130C as opposed to edge computing device 110A or 110B to not overwhelm an edge device with too big of a computational workload, as described below with reference to FIG. 1 and FIG. 2. This is done in cases where edge computing device 110 is a simple device that does not have the capacity to perform additional tasks beyond its designed function or if the implementation preference is to use the edge server such that the edge. Edge server 130C includes local ML model 114C and IDDF program 112. In an embodiment, the local ML model is not included on one or more edge computing devices (e.g., edge computing device 110C) and instead, sends ML model inputs from edge computing device 110C to edge server 130C where those inputs can be passed through local ML model 114C. The output of local ML model 114C on edge server 130C may then be sent back to edge computing device 110C. Local ML model 114C is an instance of a main ML model (e.g., ML model 122) that has been deployed from the cloud (e.g., cloud data center 120) to edge server 130C to enable machine learning at the edge through a ML application (not shown) on edge server 130C. Edge server 130C may include internal and external hardware components, as depicted and described in further detail with respect to FIG. 3.

When IDDF program 112 cannot be run completely on an edge device, IDDF program 112 can be hosted by an edge server (e.g., edge server 130C) that the edge device is in communication with, as shown in FIG. 1C. The filtering and running of a send back ML model is run on IDDF program 112 of edge server 130C. This is done in cases where edge computing device 110C is a simple device that does not have the capacity to perform additional tasks beyond its designed function or if the implementation preference is to use the edge server such that the edge computing device can use its resources for performing other tasks. This is also done to preserve the benefit of edge computing because sending all the data from thousands of edge devices to an edge server would still take up a large portion of the network and defeat the purpose of data filtering. IDDF program 112 on edge server 130C only ingests data from the same type of model and edge device that IDDF program 112 is trained to look for. All other types of devices that are registered to edge server 130C and relaying information are ignored by IDDF program 112 on edge server 130C. In some embodiments where edge server 130C connects to multiple different types of edge devices, multiple different instances of IDDF program 112 may exist for the different edge devices running different local ML models.

In embodiments in which the user feedback filter is enabled with a user interface (e.g., user interface 116C), the filtering done on the edge server (e.g., edge server 130C) is done by an edge user flagging datapoints that the edge user believes are incorrect predictions (as described in sub-step 211 of FIG. 2 below). These flagged datapoints will be prioritized by IDDF program 112 to be sent to the edge server (e.g., edge server 130C) since they are the least computationally heavy operations of IDDF program 112 and the most accurate account of local ML model 114C performing incorrectly or correctly. In some embodiments, some or all remaining unflagged datapoints will be sent to edge server 130C for further filtering according to network constraints. Once edge server 130C receives data from edge computing device 110C, IDDF program 112 on edge server 130C runs the remaining filters and/or a send back ML model (as described in step 210 and/or 215 in FIG. 2 below).

FIG. 2 is a flowchart 200 depicting operational steps of IDDF program 112, for filtering and returning retraining data to counter drift and bias in machine learning models at the edge, running on edge computing device 110A of FIG. 1A, running on edge computing device 110B and edge server 130B of FIG. 1B, or running on edge server 130C of FIG. 1C, in accordance with an embodiment of the present invention. It should be appreciated that the process depicted in FIG. 2 illustrates one possible iteration of IDDF program 112, which can be repeated once a set amount of inference data is received or for each piece of inference data received or on a periodic basis (e.g., once per day, once per week, etc.).

In step 205, IDDF program 112 receives inference data. In an embodiment, at an edge device, IDDF program 112 receives inference data. For example, at edge computing device 110A, IDDF program 112 receives inference data from local ML model 114A. Inference data can include edge device information, type of edge device, location of edge device, time that the local ML model was used, input data to the local ML model, output data of the local ML model, feedback data from the user if provided on performance of the local ML model, frequency of use of the local ML model, user profile information associated with the edge computing device or user accessing the model (i.e., individual characteristics of the user), information from users that opt in to link other applications or social media profiles to the edge computing device, etc.

Input data to a local ML model (e.g., local ML model 114A) can include data that the edge device is employed to collect, i.e., data coming from surrounding environmental sensors or a GUI, and the type of data depends completely on the type of model deployed and how the sensors are configured. For example, if local ML model 114C on edge computing device 110C is a camera used to detect whether there is an intruder coming into someone's house. The camera is constantly collecting data, so there will a constant stream of data at the edge. However, most of the data is useless because usually there is no one walking around the door of the house, so it can be discarded at the edge. Thus, the goal is to send back only the most interesting datapoints (e.g., when someone is trying to open the door). At every timepoint though (as determined by the data scientist, e.g., possibly every frame of the video or possibly every second), local ML model 114C still runs inference on the live video (inference data for the model) and determines whether there is an intruder.

In step 210, IDDF program 112 runs the inference data through a set of filters and/or models. In an embodiment, at an edge computing device and/or an edge server (e.g., edge computing device 110A or 110B and/or edge server 130B or 130C), IDDF program 112 runs the inference data through a set of filters as a first step in determining whether the inference data should be sent back to cloud data center 120. Only inference data that makes it through at least one of the filters and/or models will move on to step 215 and may be referred to as filtered inference data. In some embodiments, IDDF program 112 runs the inference data through an edge user flag filter 211, a bias detection model 212, a drift detection model 213, and a data scientist criteria filter 214. If the inference data is flagged by at least one of the filters and/or models, then IDDF program 112 proceeds with that filtered inference data to step 215. In other embodiments where user feedback is not provided, IDDF program 112 runs the inference data through only a bias detection model 212, a drift detection model 213, and a data scientist criteria filter 214. In some embodiments, IDDF program 112 runs the inference data through each filter and/or model consecutively in any order according to computing resources of the edge device, e.g., edge computing device 110A or 110B and/or the edge server, e.g., edge server 130B or 130C. In other embodiments, IDDF program 112 runs the inference data through each filter and/or model simultaneously.

In embodiments in which an edge computing device (e.g., edge computing device 110B) does not have enough computing resources to perform or handle all of the filters and models, IDDF program 112 performs this step 210 partially on edge computing device 110B and partially on edge server 130B, as shown in FIG. 1B. In some embodiments in which an edge computing device (e.g., edge computing device 110C) does not have enough computing resources to perform or handle all of the filters and models, IDDF program 112 performs this step 210 entirely on edge server 130C, as shown in FIG. 1C. In these embodiments, IDDF program 112 may perform the edge user flag filter 211, the bias detection model 212, the drift detection model 213, and/or the data scientist criteria filter 214 on the respective edge server.

Sub-step 211 applies in embodiments in which a user interface, e.g., user interface 116A, is available to a user for providing feedback on outputs of the local ML model, e.g., local ML model 114A, 114B, or 114C. In an embodiment, IDDF program 112 enables a user to provide feedback on datapoints (i.e., predictions/inferences) output by the local ML model (e.g., local ML model 114A, 114B, or 114C). User feedback can be in the form of the user disagreeing with a prediction/inference or marking the prediction/inference as questionable, i.e., any indication by the user that the prediction/inference datapoint is incorrect or should be reviewed. Responsive to IDDF program 112 receiving user feedback about a datapoint, i.e., the inference data, IDDF program 112 flags the datapoint for sending back to cloud data center 120. For a flagged datapoint, IDDF program 112 outputs a binary result of one (1) for each flagged datapoint. For unflagged datapoints or for all the datapoints in embodiments with no user interface, IDDF program 112 outputs a binary result of zero (0) for each datapoint.

In sub-step 212, IDDF program 112 runs the inference data through a bias detection model. In an embodiment, IDDF program 112 runs the inference data through a bias detection model, i.e., a classification (supervised predictive) ML model trained on the cloud using the same training data as ML model 122. The training data is constantly being updated from the original training dataset with prior runs of IDDF program 112 sending back filtered data that is used for further training. The bias detection model is trained on whether or not ML model 122 made the correct prediction or not for each instance of the data. This allows the bias detection model to guess whether new data received at the edge is likely to be misclassified by the local ML model (e.g., local ML model 114A, 114B, or 114C). For training the bias detection model, IDDF program 112 feeds the training and testing datasets through ML model 122 and labels data into two groups: the datapoints the model categorizes correctly and the datapoints the model categorizes incorrectly. These become the new labels for the bias detection model, which is trained to detect whether the model is likely to categorize incoming datapoints correctly or not. The original model was trained to predict something (e.g., cost, temperature, etc.). That feature of the data (or column) is the target, i.e., the thing the model predicts based on the other data. However, that piece of data is irrelevant in the bias detection model, so that feature is replaced with the new feature of whether that instance of data was categorized correctly or not. This new feature becomes the new target feature since that is the target for the bias detection model to predict. IDDF program 112 runs bias detection model to predict whether the local ML model (e.g., local ML model 114A, 114B, or 114C) is likely to categorize incoming datapoints correctly or not.

The bias detection model aims to predict how similar a certain datapoint (i.e., the inference datapoint run through the local ML model) is with previous datapoints that the local ML model (e.g., local ML model 114A, 114B, or 114C) has predicted incorrectly, thereby revealing model biases. The bias detection model detects whether the inference data is likely to have been a datapoint that the local ML model (e.g., local ML model 114A, 114B, or 114C) misclassified based on the datapoint's similarity to previous datapoints the main or local ML model performed poorly on. The bias detection model assigns a confidence score to the datapoint to quantify how likely the main or local ML model was biased towards this datapoint. In an embodiment, IDDF program 112 receives the confidence score output by the bias detection model for the inference data or datapoint. The confidence score can be between zero (0) and one (1), in which the higher the confidence score, the more likely it is necessary to send the datapoint back to the cloud data center for use in retraining ML model 122 before a copy is redeployed as a local ML model, e.g., local ML model 114A, 114B, or 114C on edge computing device 110A, 110B or edge server 130C.

In sub-step 213, IDDF program 112 runs the inference data through a drift detection model. In an embodiment, IDDF program 112 runs the inference data through a drift detection model, i.e., a ML model trained on the cloud using the same training data as the main ML model (e.g., ML model 122). The drift detection model operates as a lightweight anomaly detection ML model that can be based off of any unsupervised clustering algorithm, such as Density-based Spatial Clustering of Applications with Noise (DBSCAN), Cluster-based Local Outlier Factor (CBLOF), tree-based methods such as Isolation Forests, or simple statistical calculations like Box Plots based on how features deviate from the training set. The choice of algorithm depends on the type most suitable for the dataset and edge device computing constraints. The drift detection model outputs a decimal score normalized to fall within the zero (0) to one (1) range with 0 meaning clearly similar to prior data and 1 meaning extremely deviant.

The purpose of the drift detection model is to identify whether any of the inference data at the edge has drifted far from what the most recent ML model on cloud data center 120 (e.g., ML model 122) was trained to see. The drift detection model detects how different this datapoint is from most other points seen in training the ML model 122 on cloud data center 120 and outputs a corresponding drift/anomaly score. The more different this datapoint is, the more likely the local model may have performed poorly on the datapoint, and therefore, the more valuable in sending the datapoint back to cloud data center 120 for use in retraining the ML model 122.

In sub-step 214, IDDF program 112 performs a data scientist criteria filter on the inference data. In an embodiment, IDDF program 112 compares the inference data or datapoint to criteria that a data scientist has deemed important for model analysis and retraining. The criteria may include, but is not limited to, datapoints with values within a particular range or predictions the original model made that the data scientist marked as potentially incorrect or biased. The criteria are set by a data scientist for the most recent ML model, e.g., ML model 122 of cloud data center 120. In an embodiment, IDDF program 112 scores each data point run through the data scientist criteria filter from zero (0) to one (1) based on how well the datapoint satisfies the given criteria.

In step 215, IDDF program 112 runs outputs from the set of filters through a send back ML model and receives a final score output by the send back ML model. In embodiments as shown in FIG. 1B, in which a portion of the filtering step 210 is performed on edge server 130B, IDDF program 112 on edge server 130B performs this step 215, of running the outputs through the send back ML model and receiving a final score. The up to four outputs from step 210 (depending on which filters are employed) each have a value ranging between 0 and 1. In an embodiment, the send back ML model is a logistic regression ML model. In an embodiment, the send back ML model is trained to take in the up to four outputs (from filters and models 211-214) as input features and outputs a probability (i.e., final score) between zero (0) and one (1) that the datapoint should be sent back to cloud data center 120. The send back ML model can be trained using supervised training by a data scientist who creates and labels a synthetic dataset that reflects a selected prioritization and can adjust the filters as needed.

In several embodiments, IDDF program 112 is designed to have the four filters and send back ML model separate such that the filters can be updated independently. In other embodiments, IDDF program 112 can be trained as one stacked model or layered neural network with the filters and send back ML model combined.

In an embodiment, the send back ML model is trained to assign a final score to datapoints based on a prioritization (i.e., weighting) of the output from the edge user flag filter being the highest prioritization, then the outputs of the bias detection model and drift detection model being next highest prioritization, and then the output from the data scientist criteria filter being the least prioritization. This order prioritizes datapoints that have definitely been misclassified (as determined by the edge user flag filter) and require further analysis, to datapoints that are likely to have been misclassified because they are either different from datapoints seen before or are similar to previously misclassified datapoints, and finally to datapoints that a data scientist has an interest in collecting for further analysis. The send back ML model is trained by creating a synthetic dataset with four feature columns each representing an output from each of the four filters of step 210, which each have a value between 0 and 1. Each row is scored according to the prioritization and the importance of collecting a certain datapoint. For example, the send back ML model assigns a final score of one (1) if the datapoint has both a very high drift score and a 1 from the edge user flag versus the model assigning a final score of zero (0) to a datapoint if it has a very low data scientist criteria score but is otherwise normal.

In decision 220, IDDF program 112 determines whether the final score meets a send back threshold. In an embodiment, IDDF program 112 compares the final score output by the send back ML model to a send back threshold, i.e., a threshold score between zero (0) and one (1) required for sending back data to the cloud data center, e.g., 0.8. The send back threshold is based on network conditions and can be adjusted by an administrator (e.g., data scientist that creates/updates the filters/models 211-214) according to network conditions. In order to not flood the network with data, the send back threshold for sending data back can have a direct relationship with network traffic, i.e., when network traffic is high, the send back threshold increases, and when network traffic is low, the send back threshold decreases.

In an embodiment, IDDF program 112 measures network traffic by sending a ping and measuring the Round Trip Time (RTT) of a packet of data. This provides a very lightweight measure of network latency, which has a direct effect on performance/throughput of a window-based protocol or any response-request protocol. IDDF program 112 sends pings to an IP address responsible for model monitoring every 15 seconds by default, but can be adjusted between 2 seconds and 30 seconds depending on a level of granularity desired. In an embodiment, an RTT of >400 ms is considered slow, and thus, IDDF program 112 increases the send back threshold according to the equation: (1−current threshold)/2, but never exceeding one (1). An RTT between 250 ms and 400 ms is considered normal, and thus the send back threshold is maintained. An RTT <250 ms is considered fast, and thus IDDF program 112 decreases the send back threshold by 0.1 (until the threshold is 0.1) every ping that is measured to be less than 250 ms.

If IDDF program 112 determines the final score does not meet the send back threshold (decision 220, NO branch), then IDDF program 112 proceeds to step 225 and discards (i.e., deletes or removes in some way) a preset percentage of the inference data at the edge and sends the remaining percentage to the cloud labelled as non-filtered data, e.g., 90% is discarded at edge computing device 110A and 10% is sent back to cloud data center 120 and that 10% of inference data is labelled as non-filtered data. If IDDF program 112 determines the final score does meet the send back threshold (decision 220, YES branch), then IDDF program 112 proceeds to step 230 and queues the inference data to be sent back to the cloud (e.g., cloud data center 120). Thus, only a subset of the inference data is sent back to cloud data center 120 with datapoints that do not meet the send back threshold being discarded at the edge.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In FIG. 3, computing environment 300 contains an example of an environment for the execution of at least some of the computer code involved in performing the inventive methods, such as optimizing unstructured document analysis 316. In addition to block 316, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 316, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processors set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 316 in persistent storage 313.

Communication fabric 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 316 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

What is claimed is:

1. A computer-implemented method comprising:
receiving, by one or more processors, at an edge device running a local instance of a machine learning (ML) model, a set of inference data comprising a plurality of datapoints, wherein the local instance of the ML model is a deployed version of the ML model running in a cloud environment, and wherein the ML model was trained in the cloud environment and then deployed to the edge device;
running, by the one or more processors, the plurality of datapoints through one or more filters to determine a probability for each datapoint of whether a respective datapoint should be sent back to the cloud environment and used for retraining the ML model; and
determining, by the one or more processors, for each datapoint, whether the probability for the respective datapoint meets a send back threshold that is required to be met before the respective datapoint is sent back to the cloud environment.

2. The computer-implemented method of claim 1, wherein running the plurality of datapoints through the one or more filters comprises:
running, by the one or more processors, the plurality of datapoints through a bias detection model that outputs a bias score for each datapoint on how likely the respective datapoint is to have been misclassified by the local instance of the ML model;
running, by the one or more processors, the plurality of datapoints through a drift detection model that outputs a drift score for each datapoint on how different the respective datapoint is from other datapoints used to train the ML model;
running, by the one or more processors, the plurality of datapoints through a criteria filter that outputs a criteria score for how well each datapoint satisfies a preset set of criteria; and
running, by the one or more processors, the bias score, the drift score, and the criteria score for each datapoint through a send back ML model that outputs a final score for each datapoint of the probability of whether the respective datapoint should be sent back to the cloud environment for retraining the ML model.

3. The computer-implemented method of claim 2, wherein running the plurality of datapoints through the one or more filters further comprises:
running, by the one or more processors, at the edge device, the plurality of datapoints through a user flag filter that outputs a flag score based on whether the respective datapoint was flagged as an incorrect inference by a user.

4. The computer-implemented method of claim 2, wherein running the plurality of datapoints through the bias detection model, running the plurality of datapoints through the drift detection model, running the plurality of datapoints through the criteria filter, running the bias score, the drift score, and the criteria score for each datapoint through the send back ML model, and determining whether the final score for a respective datapoint meets the send back threshold are completed on the edge device.

5. The computer-implemented method of claim 2, wherein running the plurality of datapoints through the bias detection model, running the plurality of datapoints through the drift detection model, running the plurality of datapoints through the criteria filter, running the bias score, the drift score, and the criteria score for each datapoint through the send back ML model, and determining whether the final score for a respective datapoint meets the send back threshold are completed on an edge server that communicates with the edge device.

6. The computer-implemented method of claim 3, wherein the send back ML model is a logistic regression ML model trained to take the flag score, the bias score, the drift score, and the criteria score for each datapoint as input features and outputs the probability as the final score between zero (0) and one (1) that the respective datapoint should be sent back to the cloud environment.

7. The computer-implemented method of claim 3, wherein the send back ML model is trained to assign the final score for each datapoint based on a weighting of the flag score, the bias score, the drift score, and the criteria score, wherein the flag score has a highest weighting, the bias score and the drift score have a next highest weighting, and the criteria score has a lowest weighting.

8. The computer-implemented method of claim 1, wherein the send back threshold dynamically adjusts based on network conditions between the edge device and the cloud environment.

9. A computer program product comprising:
one or more computer readable storage media and program instructions collectively stored on the one or more computer readable storage media, the stored program instructions comprising:
program instructions to receive, at an edge device running a local instance of a machine learning (ML) model, a set of inference data comprising a plurality of datapoints, wherein the local instance of the ML model is a deployed version of the ML model running in a cloud environment, and wherein the ML model was trained in the cloud environment and then deployed to the edge device;
program instructions to run the plurality of datapoints through one or more filters to determine a probability for each datapoint of whether a respective datapoint should be sent back to the cloud environment and used for retraining the ML model;
program instructions to determine whether the probability for the respective datapoint meets a send back threshold that is required to be met before the respective datapoint is sent back to the cloud environment.

10. The computer program product of claim 9, wherein the program instructions to run the plurality of datapoints through the one or more filters comprise:
program instructions to run the plurality of datapoints through a bias detection model that outputs a bias score for each datapoint on how likely the respective datapoint is to have been misclassified by the local instance of the ML model;
program instructions to run the plurality of datapoints through a drift detection model that outputs a drift score for each datapoint on how different the respective datapoint is from other datapoints used to train the ML model;
program instructions to run the plurality of datapoints through a criteria filter that outputs a criteria score for how well each datapoint satisfies a preset set of criteria; and
program instructions to run the bias score, the drift score, and the criteria score for each datapoint through a send back ML model that outputs a final score for each datapoint of the probability of whether the respective datapoint should be sent back to the cloud environment for retraining the ML model.

11. The computer program product of claim 10, wherein the program instructions to run the plurality of datapoints through the one or more filters further comprise:
program instructions to run, at the edge device, the plurality of datapoints through a user flag filter that outputs a flag score based on whether the respective datapoint was flagged as an incorrect inference by a user.

12. The computer program product of claim 10, wherein the program instructions to run the plurality of datapoints through the bias detection model, run the plurality of datapoints through the drift detection model, run the plurality of datapoints through the criteria filter, run the bias score, the drift score, and the criteria score for each datapoint through the send back ML model, and determine whether the final score for the respective datapoint meets the send back threshold are completed on the edge device.

13. The computer program product of claim 10, wherein the program instructions to run the plurality of datapoints through the bias detection model, run the plurality of datapoints through the drift detection model, run the plurality of datapoints through the criteria filter, run the bias score, the drift score, and the criteria score for each datapoint through the send back ML model, and determine whether the final score for the respective datapoint meets the send back threshold are completed on an edge server connected to the edge device.

14. The computer program product of claim 11, wherein the send back ML model is a logistic regression ML model trained to take the flag score, the bias score, the drift score, and the criteria score for each datapoint as input features and outputs the probability as the final score between zero (0) and one (1) that the respective datapoint should be sent back to the cloud environment.

15. The computer program product of claim 11, wherein the send back ML model is trained to assign the final score for each datapoint based on a weighting of the flag score, the bias score, the drift score, and the criteria score, wherein the flag score has a highest weighting, the bias score and the drift score have a next highest weighting, and the criteria score has a lowest weighting.

16. The computer program product of claim 9, wherein the send back threshold dynamically adjusts based on network conditions between the edge device and the cloud environment.

17. A computer system comprising:
one or more computer processors;
one or more computer readable storage media;
program instructions collectively stored on the one or more computer readable storage media for execution by at least one of the one or more computer processors, the stored program instructions comprising:
program instructions to receive, at an edge device running a local instance of a machine learning (ML) model, a set of inference data comprising a plurality of datapoints, wherein the local instance of the ML model is a deployed version of the ML model running in a cloud environment, and wherein the ML model was trained in the cloud environment and then deployed to the edge device;
program instructions to run the plurality of datapoints through one or more filters to determine a probability for each datapoint of whether a respective datapoint should be sent back to the cloud environment and used for retraining the ML model;
program instructions to determine whether the probability for the respective datapoint meets a send back threshold that is required to be met before the respective datapoint is sent back to the cloud environment.

18. The computer system of claim 17, wherein the program instructions to run the plurality of datapoints through the one or more filters comprise:
program instructions to run the plurality of datapoints through a bias detection model that outputs a bias score for each datapoint on how likely the respective datapoint is to have been misclassified by the local instance of the ML model;
program instructions to run the plurality of datapoints through a drift detection model that outputs a drift score for each datapoint on how different the respective datapoint is from other datapoints used to train the ML model;
program instructions to run the plurality of datapoints through a criteria filter that outputs a criteria score for how well each datapoint satisfies a preset set of criteria; and
program instructions to run the bias score, the drift score, and the criteria score for each datapoint through a send back ML model that outputs a final score for each datapoint of the probability of whether the respective datapoint should be sent back to the cloud environment for retraining the ML model.

19. The computer system of claim 18, wherein the program instructions to run the plurality of datapoints through the one or more filters further comprise:
program instructions to run, at the edge device, the plurality of datapoints through a user flag filter that outputs a flag score based on whether the respective datapoint was flagged as an incorrect inference by a user.

20. The computer system of claim 19, wherein the send back ML model is a logistic regression ML model trained to take the flag score, the bias score, the drift score, and the criteria score for each datapoint as input features and outputs a probability as the final score between zero (0) and one (1) that the respective datapoint should be sent back to the cloud environment.
